(19) United States
(12) Patent Application Publication
(10) Pub. No.: US 2006/0277068 A1
(43) Pub. Date: Dec. 7, 2006

(54) Information processing terminal apparatus

(75) Inventors: Tatsuya Shiobara, Tokyo (JP); Masafumi Kobayashi, Kanagawa (JP); Hiroyuki Araki, Tokyo (JP)

Correspondence Address: SCULLY SCOTT MURPHY & PRESSER, PC, 400 GARDEN CITY PLAZA, SUITE 300, GARDEN CITY, NY, 11530, US

(73) Assignee: OLYMPUS MEDICAL SYSTEMS CORP., Tokyo (JP)

(21) Appl. No.: 11/437,064

(22) Filed: May 19, 2006

(30) Foreign Application Priority Data
May 19, 2005 (JP) 2005-146198

(51) Int. Cl. G06Q 10/00

(52) U.S. Cl. 705/2

(57) ABSTRACT

A medical data management system is of such a structure that a medical information system and an equipment master management apparatus are connected via a network such as the Internet. The medical information system includes one or more personal computers (PCs), mobile terminals wirelessly connected to access points provided for PCs, respectively, and a server which controls transmission and reception of data to and from an external system such as the equipment master management apparatus.

### CROSS-REFERENCE TO RELATED APPLICATIONS

This application is based upon and claims the benefit of priority from the prior Japanese Patent Application No. 2005-146198, filed on May 19, 2005, the entire contents of which are incorporated herein by reference.

### BACKGROUND OF THE INVENTION

1. Field of the Invention

The present invention relates to medical management technologies, and it particularly relates to a medical data management system and a medical data updating system.

2. Description of the Related Art

Generally speaking, a medical information system used in hospitals and such other facilities requires periodic system maintenance so as to ensure trouble-free use by the users. To carry out system maintenance common to a number of facilities, it is desirable that unified master data be used independently of individual facilities (see Reference (1) in the following Related Art List, for instance).

Related Art List

(1) Japanese Patent Application Laid-Open No. 2003-108837.

Furthermore, in recent years, the number of medical equipment and medicines has already reached an enormous level and is still increasing.

The present inventors have come to realize that in the present situation the registration of medical equipment or medicines in the database in a medical facility cannot often be made in time for the use of the products newly introduced or there may be failed or missing registrations, which disturb the convenience and accuracy expected of identification information used in the system. Under such circumstances, doctors and nurses have to undergo a complex and time-consuming process of temporarily stopping the use of a medical equipment or medicine to be used, registering the new medical equipment or medicine in the database and again reading the identification information thereon before use.

### SUMMARY OF THE INVENTION

The present invention has been made in view of the foregoing circumstances and a general purpose thereof is to provide a technology which ensures medical action and treatment without interruption even when the identification information on medical equipment and medicine to be used in the medical action and treatment is not yet registered in the database.

In order to solve the above problems, a medical data management system according to one embodiment of the present invention includes a first medical information management apparatus and a second medical information management apparatus, and the first medical information management apparatus includes: a first database which contains a plurality of first master data in which identification information on a plurality of medical equipment have been associated with medical equipment information; and a first transceiver which transmits or receives information to or from the second medical information management apparatus. The second medical information management apparatus includes: a second database which contains a plurality of second master data in which identification information on a plurality of medical equipment have been associated with medical equipment information; an acquisition unit which acquires the identification information attached to the medical equipment; a verification unit which verifies whether the identification information acquired by the acquiring unit is contained in the second database or not; and a second transceiver which transmits or receives information to or from the first medical information management apparatus. When the identification information is not contained in the second database as a result of verification by the verification unit, the second transceiver transmits to the first medical information management apparatus an inquiry request signal with which to inquire about whether the identification information not contained in the second database is contained in the first master data or not.

Another embodiment of the present invention relates to a medical data updating system. This medical data updating system includes a first medical information management apparatus and a second medical information management apparatus, and the first medical information management apparatus includes: a first database which contains a plurality of first master data in which identification information on a plurality of medical equipment have been associated with medical equipment information; an update data generator which extracts part of the plurality of first master data so as to generate update data; and a transmitter which transmits the update data to the second medical information management apparatus. The second medical information management apparatus includes: a receiver which receives the update data transmitted from the first medical information management apparatus; a second database which contains a plurality of second master data in which identification information on a plurality of medical equipment have been associated with medical equipment information; an update determination unit which determines whether the second master data contained in the second database are to be updated or not; and an updating unit which updates the second master data contained in the second database, based on the update data, when it is determined that the updating is necessary as a result of the update determination unit.

It is to be noted that arbitrary combinations of the aforementioned constituting elements and the implementations of the invention in the form of method, apparatus, system, computer program, data structure and so forth are effective as and encompassed by the embodiments of the present invention.

### BRIEF DESCRIPTION OF THE DRAWINGS

Embodiments will now be described by way of examples only, with reference to the accompanying drawings which are meant to be exemplary, not limiting and wherein like elements are numbered alike in several Figures in which:

FIG. 1 illustrates an overall structure example of a medical management system according to one embodiment of the present invention;

FIG. 2 illustrates a structure example of an equipment master management apparatus shown in FIG. 1;

FIG. 3 illustrates a structure example of a PC shown in FIG. 1;

FIG. 4 illustrates a structure example of a mobile terminal shown in FIG. 1;

FIG. 5 is a flowchart showing an operation example of a mobile terminal shown in FIG. 4;

FIG. 6 is a flowchart showing an operation example of a PC shown in FIG. 3;

FIG. 7 is a flowchart showing an operation example of the equipment master management apparatus shown in FIG. 2;

FIG. 8 is a flowchart showing an operation example of a PC shown in FIG. 3;

FIG. 9 illustrates a structure example of a PC according to a modification of the present embodiment; and

FIG. 10 is a flowchart showing an operation example of a medical updating system according to a modification of the present embodiment.

### DETAILED DESCRIPTION OF THE INVENTION

The invention will now be described by reference to the preferred embodiments. This does not intend to limit the scope of the present invention, but to exemplify the invention.

Before a specific description is given of embodiments of the present invention, a medical data management system to which the embodiments are applicable will be outlined below. A medical data management system according to the present embodiments includes a first medical information management apparatus which manages, in a unified manner, data on medical equipment and the like belonging to a plurality of medical facilities (hereinafter referred to as “equipment master management apparatus”), a second medical information management apparatus which manages data on medical equipment and the like at each medical facility (hereinafter referred to as “hospital master management apparatus”), and a plurality of mobile terminals which are wirelessly connected to a hospital master management apparatus.

Here, the “second medical information management apparatus” includes personal computers and general-purpose computers, such as workstations, which perform the management of medical equipment and the like installed in a hospital or other medical facility. The “first medical information management apparatus”, which is an apparatus performing an overall management of data on medical services at a plurality of medical facilities, includes personal computers and general-purpose computers, such as workstations. The “medical equipment” meant here are not only the ordinary equipment used in medical services but also anything used in medical actions, which include medicines and gases. And the “medical actions” may be any of the actions taken for patients or quasi-patients at medical facilities, such as surgery, inspections, treatment, medication and nursing care.

Individual mobile terminals are used for the checking or the like of medical equipment on the spot of medical services where a variety of medical actions are taken. Such checking is done for the purpose of preventing medical mishaps due to mistaken use of medical equipment or other careless mistakes. Also, the checked medical equipment may be consumed or lost by use, so that it is necessary to supplement them. Hence, reporting the checking results to a hospital master management apparatus can cause it to perform automatic inventory management thereof.

Of the numbers of data items of medical equipment managed at an equipment master management apparatus, a hospital master management apparatus and a mobile terminal, the number of data items of medical equipment managed at an equipment master management apparatus is the largest for reasons of the respective characteristics of the apparatuses. The hospital master management apparatus manages only the data on medical equipment necessary for the medical facility where they are installed. And the number of data items of medical equipment managed by a mobile terminal is the same as that by the hospital master management apparatus. This arrangement is based on the consideration that mobile terminals cannot be used in an operating room, for instance, where wireless communication with the hospital master management apparatus cannot be established. Generally speaking, a great variety of medical equipment are used at medical facilities, and there are hundreds of thousands of data items of medical equipment to be managed by an equipment master management apparatus, which manages the medical equipment at all the medical facilities involved. On the other hand, the number of medical equipment used at each medical facility is in the thousands. Moreover, advances in medical equipment are very rapid with new devices arriving one after another, so that it is difficult for each medical facility to manage them all. It may be inefficient for a facility to manage medical equipment which it does not use as well. According to the present embodiment, therefore, the equipment master management apparatus performs management of all the medical equipment involved in a unified manner.

Under circumstances as described above, there are now no small cases where certain items of medical equipment, when checked by a mobile terminal or a hospital master management apparatus, are not registered in the database of the hospital master management apparatus belonging to the facility. In such a case, it is necessary to newly register information on such nonregistered medical equipment. However, if the registration is to be done manually at the scene of actual medical service where the medical equipment is used, the medical action will have to be interrupted, which is not desirable especially in a situation like emergency surgery. Besides, human errors can result from hasty manual registration during the current busy operation. According to the present invention, therefore, such errors are avoided by autonomous updating in place of manual registration.

In the present embodiment, when a mobile terminal has detected any nonregistered medical equipment which is not being managed by a hospital master management apparatus, the hospital master management apparatus installed in that particular medical facility makes an inquiry to the equipment master management apparatus. At this time, the hospital master management apparatus keeps in memory the identification information on the nonregistered medical equipment as “nonregistered medical equipment” until information concerning the nonregistered medical equipment is received from the equipment master management apparatus. This is because information concerning the nonregistered medical equipment may not always be sent immediately from the equipment master management apparatus. Unless the identification information on the nonregistered medical equipment is stored in memory in preparation for such a delay, another nurse or the like who uses the same nonregistered medical equipment may decide that it is nonregistered again. In such a case, the inquiry about the same nonregistered medical equipment to the equipment master management apparatus may be repeated, thus reducing the efficiency of the system as a whole. Note here that “identification information” used herein means information contained in a part of a code information printed on or attached to an individual medical equipment, which may include a number or the like for identifying the medical equipment.

Further, upon receipt of information concerning the nonregistered medical equipment from the equipment master management apparatus, the hospital master management apparatus makes an updating decision and then carries out an updating processing. This arrangement, which permits accurate updating processing with little human intervention, can effectively prevent human errors. This also ensures speedy medical actions without causing unnecessary trouble to doctors and nurses. Moreover, this ensures accurate data management of medical equipment. Hereinbelow, a detailed description with reference to drawings will be given of the structure and operation of a medical data management system according to the present embodiment.

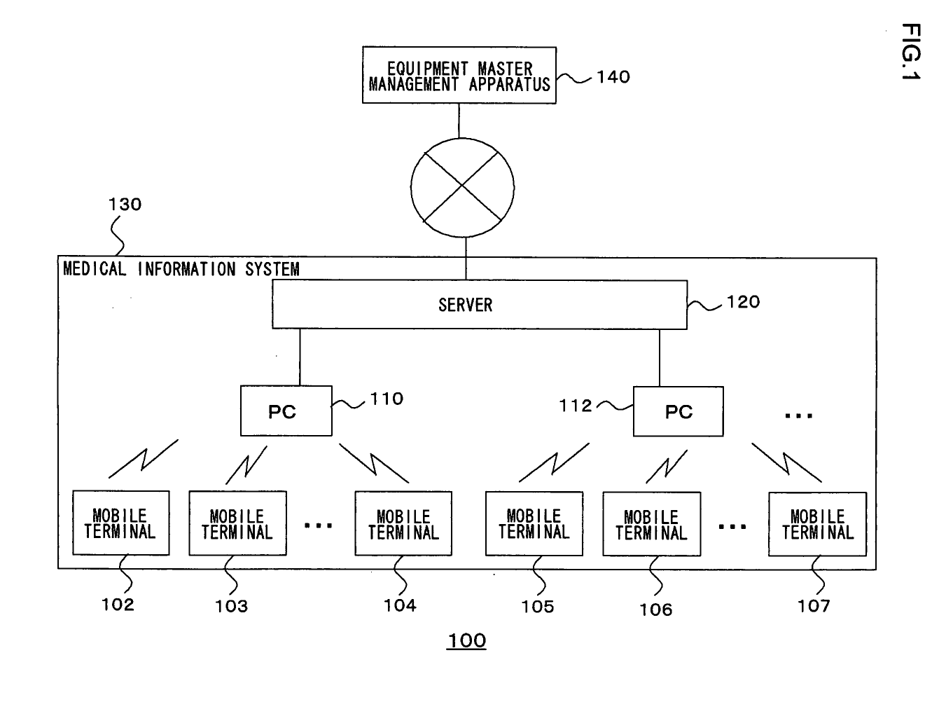

FIG. 1 illustrates an overall structure example of a medical management system according to one embodiment of the present invention. A medical data management system 100 has a structure such that a medical information system 130 and an equipment master management apparatus 140 are connected via a network such as the Internet. The medical information system 130 is provided in a hospital, for instance. The equipment master management apparatus 140 is installed in a building of a company undertaking the information management, for instance. The medical information system 130 includes a personal computer 110 (hereinafter referred to as “PC”), a PC 112, mobile terminals 102 to 104 and 105 to 107 accessible by wireless to access points provided for the PC 110 and PC 112, respectively, and a server 120 which controls the transmission and reception of data between PCs 110 and 112 and an external system such as an equipment management apparatus 140. The PC 110 and the PC 112 are installed in a nurse station of each department in the hospital, for instance, and the mobile terminals 102 to 107 are placed in each operation room and examination room, for instance. The equipment master management apparatus 140 may connect to a plurality of medical information systems 130 installed in a plurality of medical facilities via the similar network so as to manage the information on the actual implementation of each medical facility and the like in a concentrated manner. The PC 110 and the PC 112 may be replaced by computers such as a workstation or a general-purpose computer. A structure may be such that a PC 110 or 112 serves also as a server 120. In what is to follow, a description will be so made that, for simplicity of description, the PC 110 represents the PC 110 and the PC 112.

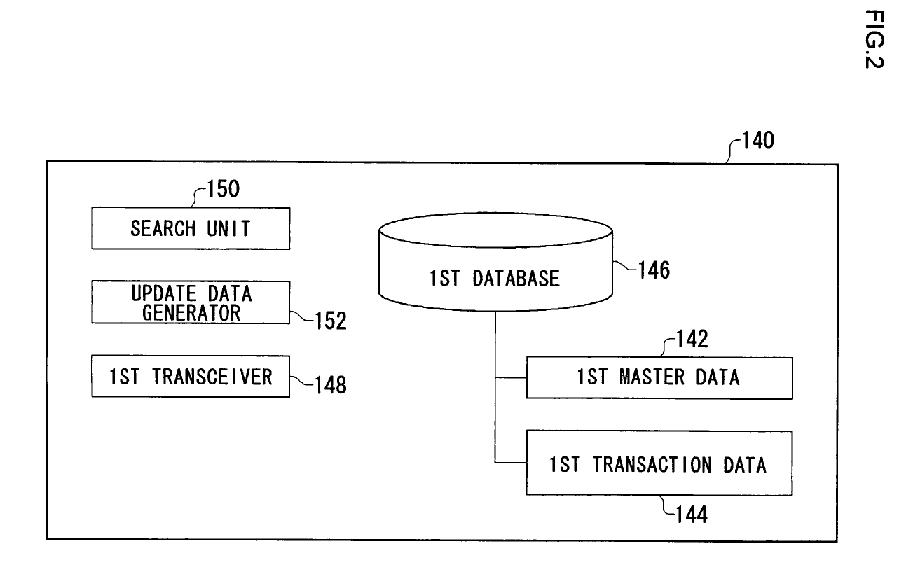

FIG. 2 illustrates a structure example of the equipment master management apparatus 140 shown in FIG. 1. The equipment master management apparatus 140 includes first master data 142 in which the names of medical equipment are associated with identification information, first transaction data 144 for managing the treatment results on surgeries, dosing and the like, a first database 146 that contains the first master data 142 and the first transaction data 144, a first transceiver 148 that carries out the processing of transmitting and receiving information to and from the PC 110, a search unit 150 that searches data contained in the first database 146, and an update data generator 152 that generates update data managed by the PC 110 and the like. The “first master data” are medical data at all of the medical facilities managed by the first medical information management apparatus, and said data contain the identification information on medical equipment and so forth.

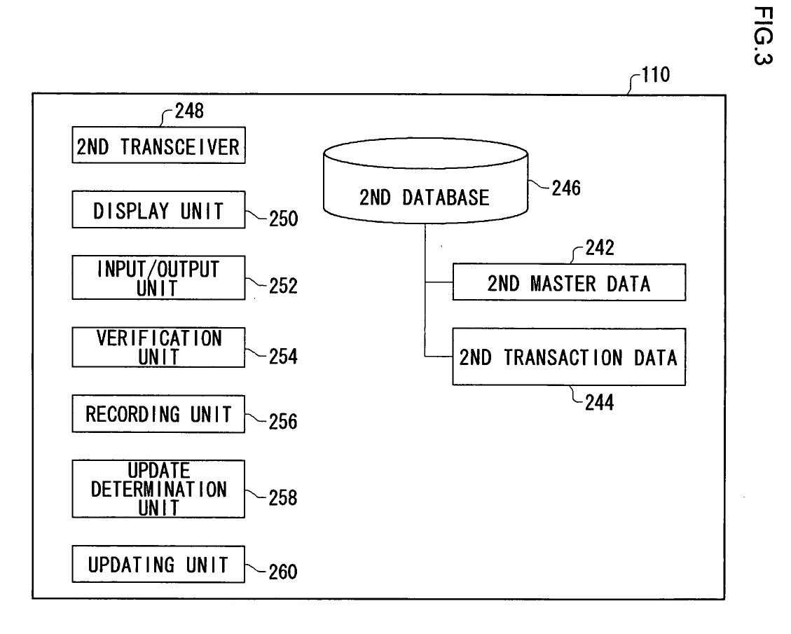

FIG. 3 illustrates a structure example of the PC 110 shown in FIG. 1. The PC 110 includes second master data 242 on equipment used in the medical information system 130 and so forth, second transaction data 244 for managing the treatment results on surgeries, dosing and the like, a second database 246 that contains the second master data 242 and the second transaction data 244, a second transceiver 248 that carries out the processing of transmitting and receiving information between the equipment master management apparatus 140 and the mobile terminal 102, a display unit 250 that carries out display processing for displaying information on a display medium such as a display, an input/output unit 252 that receives instruction from users, a verification unit 254 that verifies data contained in the second data base 246, a recording unit 256 that carries out processing of recording data in the second database 246, an update determination unit 258 that determines if data contained in the second database 246 are to be updated or not, and an updating unit 260 that updates data contained in the second database 246. The “second master data” are data for medical treatment managed individually at each of the medical facilities such as hospitals, and said data contain the identification information on medical equipment and so forth.

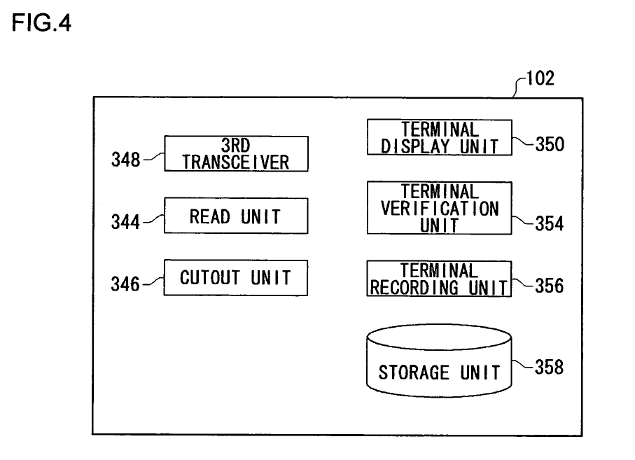

FIG. 4 illustrates a structure example of a mobile terminal 102 as shown in FIG. 1. A mobile terminal 102 includes a read unit 344 that reads code information printed on or affixed to a medical equipment, a cutout unit 346 that cuts out a necessary part from the code information read by the read unit 344, a third transceiver 348 that transmits and receives information to and from the PC 110, a terminal display unit 350 that displays information on a display medium such as the display of a terminal, a storage unit 358, a terminal verification unit 354 that verifies information against the information stored in the storage unit 358, and a terminal recording unit 356 that records information in the storage unit 358.

Using a configuration like this, accurate data management of medical equipment may be accomplished with a minimal amount of human intervention. Especially when a nonregistered device is used within a medical facility, automatic updating of the system may be performed without adding any trouble of maintenance.

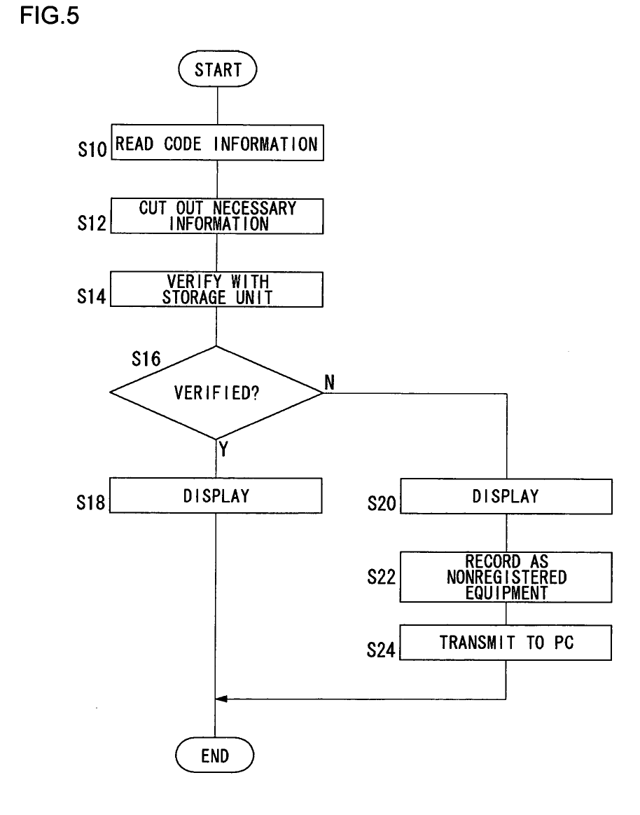

Now, the updating of medical data when identification information read by the read unit 344 of a mobile terminal 102 from a medical equipment is not in the storage unit 358, that is, when the medical equipment is a nonregistered medical equipment, will be explained with reference to FIGS. 5 to 8.

FIG. 5 is a flowchart showing an operation example of a mobile terminal 102 shown in FIG. 4. On the day of surgery, a performer of medical action reads the code information affixed to a medical equipment to be used in an operating room or the like, using the read unit 344 (S10). The code information, which may take a format of numerals, characters, figures or the like, is an expression of identification information or product name for identifying the medical equipment, together with other information thereon, such as the producing country, maker name, product number, lot number and expiration date. The code information, which is a series of numerals or symbols, is later converted into information, such as a product name of medical equipment, that can be understood by humans. In a medical facility or the like, correspondence between the names of medical equipment introduced and the identification information already assigned to the medical equipment is stored in the database or the like in advance to facilitate reference at the time of conversion.

After code information on a medical equipment is read, the cutout unit 346 cuts out the only information necessary for later verification (S12). Here “information necessary for verification” means identification information that can be checked against medical equipment stored in the storage unit 358, which may include not only an identification number or product name for identification of the medical equipment but also the producing country, maker name, product number, lot number, expiration date, or the like. Then the terminal verification unit 354 checks to see if the cutout information is contained in the storage unit 358 (S14). As a result of this checkup, when a verification has been made (Y of S16), the terminal display unit 350 displays the name and identification information of the medical equipment on a display medium such as the display of the terminal (S18). On the other hand, when a verification has not been made (N of S16), the terminal display unit 350 displays the information indicating the failure of verification and the identification information itself (S20). Further, the terminal recording unit 356 records the medical equipment meant by the identification information as a nonregistered medical equipment in the transaction data in the storage unit 358 (S22). The third transceiver 348 transmits the identification information on the nonregistered medical equipment to the PC 110 (S24).

The series of operation of a mobile terminal 102 as described above may ensure speedy medical actions by saving the trouble of a nurse or any other performer of a medical action interrupting his or her action to carry out the registration of a nonregistered medical equipment.

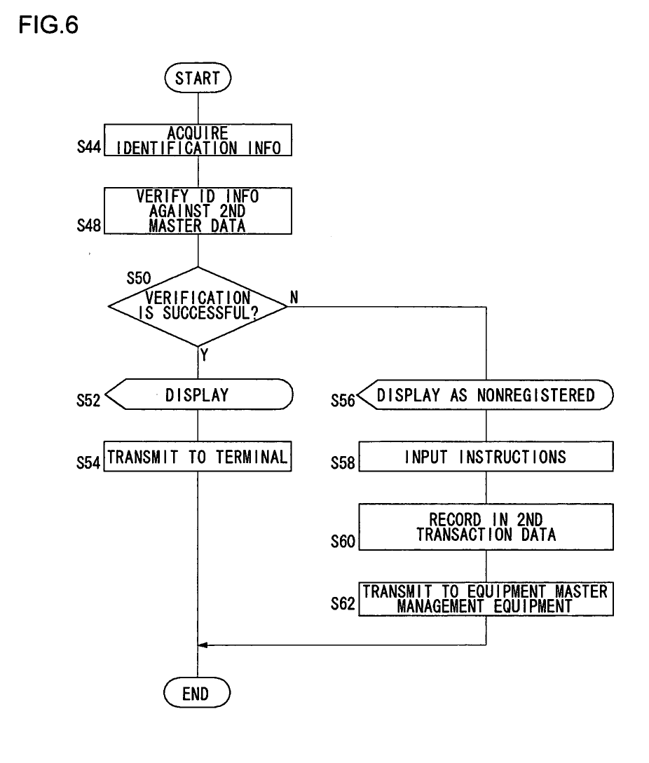

FIG. 6 is a flowchart showing an operation example of the PC 110 shown in FIG. 3. Firstly, the second transceiver 248 acquires via a mobile terminal 102 the identification information on the medical equipment determined to be unregistered by the mobile terminal 102 (S44). The verification unit 254 checks to see if the acquired identification information is contained in the second database or not (S48). As a result of verification, if it is verified (Y of S50), the display unit 250 will display the identification information and the name or names of medical equipment associated with the identification information on a display medium such as the display of the PC 110 (S52). Then the second transceiver 248 transmits the identification information and the name or names of medical equipment associated with the identification information to the mobile terminal 102 (S54). If, on the other hand, the verification is not successful (N of S50), the display unit 250 will display on the display medium such as the display of the PC 110 the information indicating that the verification has failed and said information itself (S56).

Further, when the user having seen this display instructs the input/output unit 252, such as a keyboard, to indicate an intention of inquiry to the equipment master management apparatus 140 (S58), the recording unit 256 records the not-verified identification information as a nonregistered medical equipment in the second transaction data 244 (S60). Also, the second transceiver 248 transmits to the equipment master management apparatus 140 an inquiry request signal about whether or not the identification information not contained in the second master data 242 is contained in the first master data 142 (S62). This inquiry request signal includes identification information and the like concerning the nonregistered medical equipment.

The operation of the PC 110 as described above accomplishes the updating processing of nonregistered medical equipment with little human intervention. The retention of the information on nonregistered medical equipment helps avoid the repetition of the same trouble when a nonregistered medical equipment is recognized again. Moreover, this arrangement makes it impossible for a third party to falsify the information on medical equipment with malicious intent.

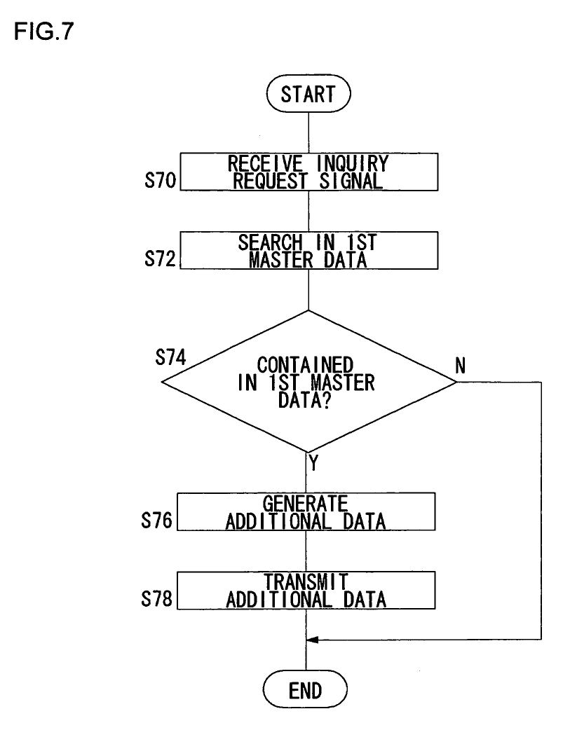

FIG. 7 is a flowchart showing an operation example of the equipment master management apparatus 140 shown in FIG. 2. Firstly, the first transceiver 148 receives the inquiry request signal sent from the PC 110 (S70). Next, the search unit 150 searches to see if inquiry identification information is contained in the first master data 142 or not (S72). When the inquiry identification information is contained in the first master data 142 as a result of search by the search unit 150 (Y of S74), the update data generator 152 generates additional data that contain the names of medical equipment and the like concerning the inquiry identification information (S76). Furthermore, the first transceiver 148 sends the additional data to the PC 110 (S78).

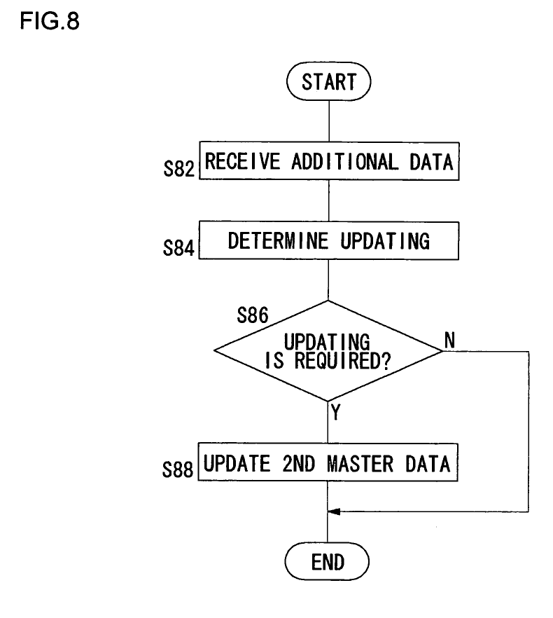

FIG. 8 is a flowchart showing an operation example of the PC 110 shown in FIG. 3. Firstly, the second transceiver 248 receives the additional data sent from the equipment master management apparatus 140 (S82). Next, based on the additional data, the update determination unit 258 determines whether the second master data 242 is to be updated or not (S84). Here, “based on the additional data . . . determines whether the second master data 242 is to be updated or not” means that when, for example, no additional data is contained in the second master data 242 and there is a registration as nonregistered medical equipment in the second transaction data 244, the updating is determined to be necessary. On the other hand, the registration as nonregistered medical equipment is not contained in the second transaction data 244, namely, when additional data concerning the updating has been sent by mistake, no updating is necessary. Also, when the additional data has already been contained in the second master data 242, namely, when the updating of the second master data 242 has already been completed, no updating is necessary. When it is determined by the update determination unit 258 that the updating is necessary (Y of S86), the updating unit 260 updates the second master data 242 contained in the second database 246 (S88).

By employing the embodiment described as above, the medical actions can be conducted without interruption even when the identification information on medical equipment and medicine to be used in the medical treatment and action is not yet registered in the database. The number of items of master data stored in the PC 110 can be minimized. Automatic updating can reduce the maintenance work for the medical equipment data.

Now, a modified version of a medical data updating system according to an embodiment of the present invention will be described. The explanation of parts identical to those of the preceding description of the embodiments will be simplified by the use of identical reference numerals.

Firstly, a medical data updating system to which the modification of the present embodiment is applicable will be outlined. A medical data updating system according to the present embodiment includes an equipment master management apparatus which manages data on medical equipment and the like belonging to a plurality of medical facilities, a PC 110 which manages medical data and the like at each medical facility and a plurality of mobile terminals which are wirelessly connected to the PC 110. Note here that the devices used for medical treatment have their respectively defined insurance points which serve as the basis of calculation of medical costs when such medical equipment are used. These insurance points are updated altogether at a predetermined time once every two years, and there are a large number of medical equipment to be updated. Thus, if the updating of the insurance points is to be managed by each medical facility, then there will be a great burden on both the human staff and the system involved at the time of updating. Besides, there may result problems of failed or missing updating since the insurance points of most of the medical equipment are to be changed.

Advances in the research and development of medical equipment are very rapid with new devices arriving one after another, so that it is difficult for each medical facility to manage them all. Furthermore, as mentioned already, a great variety of medical equipment are used at medical facilities, and there are hundreds of thousands of data items of medical equipment to be managed by an equipment master management apparatus, which manages the medical equipment at all the medical facilities involved. In fact, it is difficult, and very inefficient, for each of the medical facilities to manage the updating of all the medical equipment. Hence, the equipment master management apparatus performs the updating management of all the medical equipment involved in a unified manner.

According to a modification of the present embodiment, therefore, the equipment master management apparatus performs the updating management in a unified manner when the insurance points of medical equipment are to be updated and when new medical equipment is to be introduced. And the PC 110 installed in each medical facility determines whether updating processing is necessary or not based on an update request from the equipment master management apparatus and other information concerning the insurance points of medical equipment to be updated and the like and carries out the updating processing only when it is found necessary. In this manner, the equipment master management apparatus performs updating management in a unified manner, so that burden on each facility involved can be lightened even when the insurance points of a plurality of medical equipment are to be updated together. Moreover, freedom from human intervention reduces burden on the personnel involved and human errors. Furthermore, each medical facility can respond flexibly because it is allowed to perform updating following its decision on updating. Hereinbelow, the structure and operation of a medical data updating system according to a modification of the present embodiment will be described in detail with reference to the drawings.

Similar to the medical data management system as shown in FIG. 1 to FIG. 4, a medical data updating system according to a modification of the present embodiment includes a medical information system 130 having PCs 110 and mobile terminals 102, and an equipment master management apparatus 140. The equipment master management apparatus 140 includes first master data 142, first transaction data 144, a first database containing the first master data 142 and the first transaction data 144, a first transceiver 148, a search unit 150, and an update data generator 152.

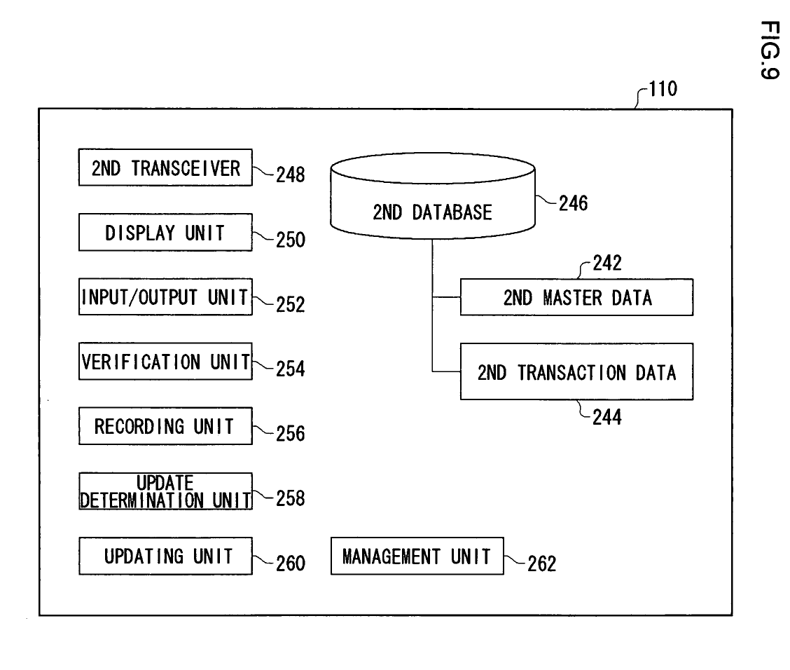

FIG. 9 illustrates a structure example of a PC 110 according to a modification of the present embodiment. The PC 110 includes second master data 242, second transaction data 244, a second database 246 containing the second master data 242 and the second transaction data 244, a second transceiver 248, a display unit 250, an input/output unit 252, a verification unit 254, a recording unit 256, an update determination unit 258, an updating unit 260, and a management unit 262 which manages management identification information on the facility in question or management apparatus itself and the dates and time. The PC 110 shown in FIG. 9 differs from that in FIG. 3 in that the management unit 262 is contained in the modification shown in FIG. 9. Also, the modification shown in FIG. 9 differs therefrom in that whether the updating is to be effected or not is determined by comparing the update data sent from the equipment master management apparatus 140 with the management identification information managed by the management unit 262. The detail will be described later.

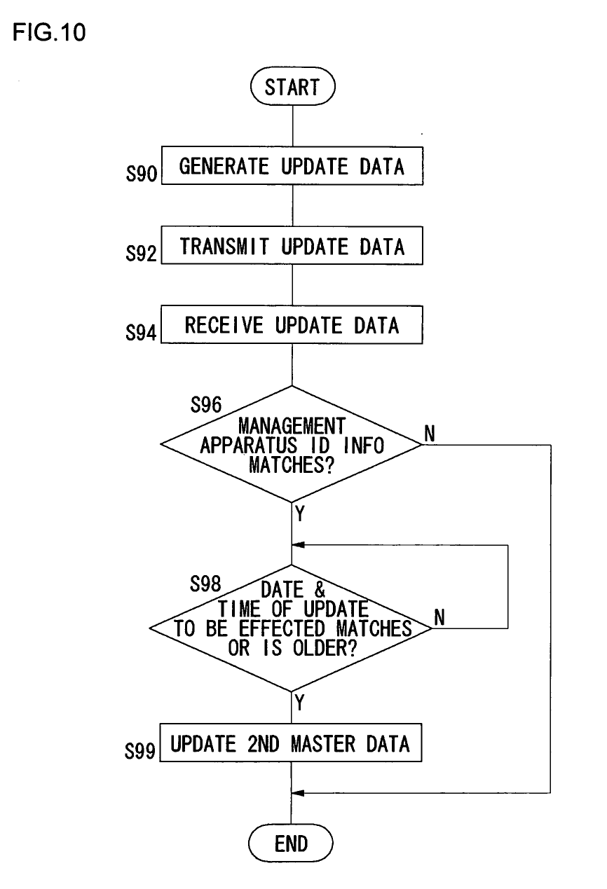

Now, the updating operation example of a medical data updating system is explained with reference to FIG. 10. FIG. 10 is a flowchart showing an operation of a medical data updating system according to a modification of an embodiment of the present invention. The operation as shown in FIG. 10 starts at the registration of information on a medical equipment to be updated in the first master data 142 contained in the first database 146 when new medical equipment are to be updated or when the insurance points of medical equipment are to be updated.

Firstly, the update data generator 152 at the equipment master management apparatus 140 generates update data by extracting part of a plurality of first master data 142 (S90). “Extracting part of first master data 142” means the extraction from first master data 142 of medical equipment whose insurance points are to be changed, out of the medical equipment used by the PC 110 to be updated. And the update data includes not only the management apparatus identification information on the PC 110 to be updated but also the names, identification information, update date and time, insurance points and the like of medical equipment to be newly added. Then the first transceiver 148 transmits update data to the PC 110 to be updated (S92).

Next, in the PC 110 the second transceiver receives the update data sent from the equipment master management apparatus 140 (S94). Then the update determination unit 258 determines, based on the update data, whether the second master data 242 contained in the second database 246 are to be updated or not. Here, “based on the update data” means that it is determined whether or not the management apparatus identification information contained in the update data is in agreement with the identification information on said PC 110 managed by the management unit 262 (S96). It further means that it is determined whether or not the update date and time is in agreement with the system date and time of said PC 110 managed by the management unit 262, whether or not the update date and time is older than the system date and time thereof (S98) or the like.

Here, when the management apparatus identification information contained in the update data is not in agreement with the identification information on the PC 110 managed by the management unit 262 (N of S96), the PC 110 belongs to a medical facility which should not be updated and therefore ends the operation without being updated. And when the management apparatus identification information contained in the update data is in agreement with the identification information on the PC 110 managed by the management unit 262 (Y of S96) and the update date and time contained in the update data is not in agreement with the system date and time of the PC 110 managed by the management unit 262 and besides the update date and time is new (N of S98), it is not yet the time for updating and thus no updating is done. On the other hand, when the management apparatus identification information contained in the update data is in agreement with the identification information on the PC 110 managed by the management unit 262 (Y of S96) and the update date and time contained in the update data is in agreement with the system date and time of the PC 110 managed by the management unit 262 or the update date and time is older than that (Y of S98), it is decided to be the time for updating and the updating unit 260 updates the second master data 242 contained in the second database 246 by the update information on the medical equipment contained in the update data (S99).

By implementing the above structure and operation, accurate updating can be accomplished even when updating of a large number of medical equipment must be done following a revision of insurance points. This will reduce the burden on the personnel and the load on the system in carrying out the updating processing. Moreover, this will reduce the possibilities of failed updating or updating error. And each medical facility can respond flexibly because it is allowed to perform updating processing following its decision on updating. Further, timely updating can be carried out even when new medical equipment are arriving one after another. It is not necessary for each medical facility to conduct the whole management.

The above description of a modification of the present embodiment is such that when there has been a revision of insurance points of medical equipment or when new medical equipment have been added, an equipment master management apparatus 140 starts updating processing for a PC 110 and the PC 110 carries out the updating processing by referring to the update date and time or the like. However, the modification is not limited thereto, and the equipment master management apparatus 140 may notify the PC 110 of the presence of update data when there has been a revision of insurance points of medical equipment or when new medical equipment have been added. In this case, the equipment master management apparatus 140 may generate and transmit update data only when it has received an update request from the PC 110. An update request from the PC 110 may be initiated by the input of an instruction from the user, for instance. The arrangement as described above allows the PC 110 to perform the updating processing independently and flexibly. The equipment master management apparatus 140 only has to perform the management of data, which makes the system design simpler with clear division of roles with the PC 110.

The present invention has been described based on the embodiments and their modifications. These embodiments are merely exemplary, and it is understood by those skilled in the art that various other modifications to the combination of each component and process thereof are possible and such modifications are also within the scope of the present invention.

While the preferred embodiments of the present invention have been described using specific terms, such description is for illustrative purposes only, and it is to be understood that changes and variations may be made without departing from the spirit or scope of the appended claims.

What is claimed is:

1. A medical data management system including a first medical information management apparatus and a second medical information management apparatus, said first medical information management apparatus including:
a first database which contains a plurality of first master data in which identification information on a plurality of medical equipment associate with medical equipment information; and
a first transceiver which transmits or receives information to or from said second medical information management apparatus, and
said second medical information management apparatus including:
a second database which contains a plurality of second master data in which identification information on a plurality of medical equipment associate with medical equipment information;
an acquisition unit which acquires the identification information attached to the medical equipment;
a verification unit which verifies whether the identification information acquired by the acquiring unit is contained in the second database or not; and
a second transceiver which transmits or receives information to or from said first medical information management apparatus,
wherein when the identification information is not contained in the second database as a result of verification by the verification unit, said second transceiver transmits to said first medical information management apparatus an inquiry request signal with which to inquire about whether the identification information not contained in the second database is contained in the first master data or not.

2. A medical data management system according to claim 1, further including a plurality of medical terminals,
wherein the acquisition unit acquires, via the medical terminal, the identification information of the medical equipment.

3. A medical data management system according to claim 1, wherein said second medical information management apparatus further includes:
a display unit which displays information indicating that the identification information is unregistered, when the identification information is not contained in the second database as a result of verification by the verification unit; and
a user instruction unit which receives an instruction from a user who has confirmed a display of the display unit,
wherein when the user instruction unit receives the instruction from a user, the second transceiver transmits the identification information, as inquiry identification information, to said first medical information management apparatus in order to inquire about whether the identification information is contained in the first database or not.

4. A medical data management system according to claim 2, wherein said second medical information management apparatus further includes:
a display unit which displays information indicating that the identification information is unregistered, when the identification information is not contained in the second database as a result of verification by the verification unit; and
a user instruction unit which receives an instruction from a user who has confirmed a display of the display unit,
wherein when the user instruction unit receives the instruction from a user, the second transceiver transmits the identification information, as inquiry identification information, to said first medical information management apparatus in order to inquire about whether the identification information is contained in the first database or not.

5. A medical data management system according to claim 3, wherein said first medical information management apparatus further includes:
a search unit which searches whether the inquiry identification information is contained in the first master data or not,
wherein when the inquiry identification information is contained in the first master data as a result of search by the search unit, the first transceiver transmits medical equipment information concerning the inquiry identification information, as additional data, to said second medical information management apparatus.

6. A medical data management system according to claim 4, wherein said first medical information management apparatus further includes:
a search unit which searches whether the inquiry identification information is contained in the first master data or not,
wherein when the inquiry identification information is contained in the first master data as a result of search by the search unit, the first transceiver transmits medical equipment information concerning the inquiry identification information, as additional data, to said second medical information management apparatus.

7. A medical data management system according to claim 5, wherein said second medical information management apparatus further includes:
an update determination unit which determines, based on the additional data, whether the second database is to be updated or not; and
a second database updating unit which updates the second database when the update determination unit determines that the updating is necessary.

8. A medical data management system according to claim 6, wherein said second medical information management apparatus further includes:
an update determination unit which determines, based on the additional data, whether the second database is to be updated or not; and
a second database updating unit which updates the second database when the update determination unit determines that the updating is necessary.

9. A medical data updating system including a first medical information management apparatus and a second medical information management apparatus, said first medical information management apparatus including:
a first database which contains a plurality of first master data in which identification information on a plurality of medical equipment associate with medical equipment information;
an update data generator which extracts part of the plurality of first master data so as to generate update data; and
a transmitter which transmits the update data to said second medical information management apparatus, and
said second medical information management apparatus including:
a receiver which receives the update data transmitted from said first medical information management apparatus;
a second database which contains a plurality of second master data in which identification information on a plurality of medical equipment associate with medical equipment information;
an update determination unit which determines whether the second master data contained in the second database are to be updated or not; and
an updating unit which updates the second master data contained in the second database, based on the update data, when it is determined that the updating is necessary as a result of the update determination unit.

10. A medical data updating system according to claim 9, wherein said second medical information management apparatus includes a management unit which manages management apparatus identification information and date and time indicative of said second medical information management apparatus,
wherein the update data further includes update management apparatus information and update date and time indicative of the management apparatus identification information on said second medical information management apparatus to be updated, and
wherein when the update management apparatus information is in agreement with the management apparatus identification information managed by the management unit, and the update date and time is in agreement with the date and time managed by the management unit or the date and time managed by the management unit is older than the update date and time, the update determination unit determines that the updating is necessary.

11. A medical data updating system according to claim 9, wherein the update data contain identification information on the plurality of medical equipment and insurance points associated with the identification information, and
wherein, in the second master data contained in the second database, the updating unit updates insurance points associated with the identification information on the medical equipment, with those contained in the update data.

12. A medical data updating system according to claim 10, wherein the update data contain identification information on the plurality of medical equipment and insurance points associated with the identification information, and
wherein, in the second master data contained in the second database, the updating unit updates insurance points associated with the identification information on the medical equipment, with those contained in the update data.
